(19) United States
(12) Patent Application Publication
(10) Pub. No.: US 2021/0055147 A1
(43) Pub. Date: Feb. 25, 2021

(54) SYSTEMS AND METHODS FOR DETERMINING FUEL ECONOMY OF A VEHICLE

(71) Applicant: Capital One Services, LLC, McLean, VA (US)

(72) Inventors: Avid Ghamsari, Frisco, TX (US); Jason Hoover, Grapevine, TX (US); Qiaochu Tang, The Colony, TX (US); Geoffrey Dagley, McKinney, TX (US); Micah Price, Plano, TX (US)

(73) Assignee: Capital One Services, LLC, McLean, VA (US)

(21) Appl. No.: 16/548,933

(22) Filed: Aug. 23, 2019

(51) Int. Cl. G01F 9/00; G06Q 30/02; G07C 5/02; G01C 22/00

(52) U.S. Cl. CPC G01F 9/001; G01C 22/00; G07C 5/02; G06Q 30/0283

(57) ABSTRACT

Disclosed are systems and methods for determining fuel economy of a vehicle. The method may include: receiving, by a processor, travel route information for the vehicle and fuel payment information for the vehicle from a first user device through a network; determining, by the processor, an amount of fuel used by the vehicle based on the received fuel payment information; determining, by the processor, fuel economy of the vehicle based on the received travel route information and the determined amount of fuel used by the vehicle; and transmitting, by the processor, the determined fuel economy of the vehicle to a second user device through the network.

### TECHNICAL FIELD

Various embodiments of the present disclosure relate generally to vehicle performance information and, more particularly, to systems and methods for determining fuel economy of a vehicle.

### BACKGROUND

When shopping for a vehicle, buyers may value certain information and/or attributes of the vehicle. For example, fuel economy, such as miles per gallon (MPG), for a select vehicle may indicate the distance the vehicle may travel per unit of fuel consumed. Many current vehicle shopping platforms provide a manufacturer MPG for a select vehicle. Further, the manufacturer MPG may include values for both estimated MPG in a city and estimated MPG on a highway for the vehicle. However, the manufacturer-provided MPG for the vehicle may not be accurate for different specific geographic locations. For example, various factors, such as traffic and road conditions, for a specific geographic location may affect an actual MPG for a select vehicle. Thus, the actual MPG for the select vehicle may be different than the manufacturer-provided MPG estimates for the vehicle.

The systems and methods of the present disclosure may solve one or more of the problems set forth above and/or other problems in the art. The scope of the current disclosure, however, is not defined by the attached claims, and not by the ability to solve any specific problem. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, systems and methods are disclosed for determining fuel economy of a vehicle. Each of the examples disclosed herein may include one or more of the features described in connection with any of the other disclosed examples.

In one embodiment, a computer-implemented method for determining fuel economy of a vehicle is disclosed. The method may include: receiving, by a processor, travel route information for the vehicle and fuel payment information for the vehicle from a first user device through a network; determining, by the processor, an amount of fuel used by the vehicle based on the received fuel payment information; determining, by the processor, fuel economy of the vehicle based on the received travel route information and the determined amount of fuel used by the vehicle; and transmitting, by the processor, the determined fuel economy of the vehicle to a second user device through the network.

In another embodiment, a computer system for determining fuel economy of a vehicle is disclosed. The computer system may include: a memory having processor-readable instructions stored therein; and at least one processor configured to access the memory and execute the processor-readable instructions, which when executed by the processor configures the processor to perform a plurality of functions, including functions for: receiving travel route information for the vehicle and fuel payment information for the vehicle from a first user device through a network; determining an amount of fuel used by the vehicle based on the received fuel payment information; determining fuel economy of the vehicle based on the received travel route information and the determined amount of fuel used by the vehicle; and transmitting the determined fuel economy of the vehicle to a second user device through the network.

In yet another embodiment, a computer-implemented method for determining fuel economy of a vehicle is disclosed. The method may include: receiving, by a processor, information of type of vehicle for the vehicle, travel route information for the vehicle, and fuel payment information for the vehicle from a first user device through a network; determining, by the processor, a distance travelled by the vehicle between fuel refills based on the received travel route information for the vehicle; determining, by the processor, an amount of fuel used by the vehicle based on the received fuel payment information; determining, by the processor, fuel economy of the vehicle based on the determined distance travelled by the vehicle between fuel refills and the determined amount of fuel used by the vehicle; and transmitting, by the processor, the determined fuel economy of the vehicle and the information of type of vehicle for the vehicle to a second user device through the network.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system architecture for determining fuel economy of a vehicle, according to one or more embodiments.

FIG. 2 depicts a flowchart of an exemplary method for determining fuel economy of a vehicle.

FIG. 3 depicts a flowchart of another exemplary method for determining fuel economy of a vehicle.

FIG. 4 depicts an example system that may execute techniques presented herein.

### DETAILED DESCRIPTION OF EMBODIMENTS

Various embodiments of the present disclosure relate generally to vehicle performance information and, more particularly, to systems and methods for determining fuel economy of a vehicle.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In general, the present disclosure provides for systems and methods for determining fuel economy of a vehicle. As used herein, “fuel economy” is the relationship between distance travelled by a vehicle and fuel consumed by the vehicle. “Fuel economy” may be a distance travelled per unit volume of fuel consumed by the vehicle and/or units of fuel per fixed distance travelled by the vehicle. For example, “fuel economy” may be expressed as miles per gallon (MPG), kilometers per liter (km/L), liters per 100 kilometers (L/100 km), gallons per 100 miles, and/or any other units for expressing distance travelled per unit volume of fuel and/or units of fuel per fixed distance travelled. Embodiments of the present disclosure may provide for retrieving information from one or more mobile applications, such as a banking, credit card, and/or automobile loan application. The retrieved information may include, for example, vehicle information for the car the user is driving, the user's travel distance, the total payment a user made for fuel, and/or the location the user was at when the user paid for the fuel. The location information may be used to estimate the cost of fuel per unit volume of fuel at that location. From one or more of the distance information, vehicle information, payment information, and the location information, the system may determine the actual fuel economy (e.g., MPG) for the vehicle.

The determined actual fuel economy information may be provided to other users via, for example, a car shopping website platform. The fuel economy information may be associated with the vehicle based on the manufacturer, model type, and/or model year of the vehicle. Such information may provide a more precise determination of the fuel economy that a specific vehicle experiences in a specific geographic location. For example, some vehicles that have a lower manufacturer-provided fuel economy value may actually experience a higher fuel economy due to driving conditions of the area the vehicle is used. Alternatively, some vehicles that have a higher manufacturer-provided fuel economy value may actually experience a lower fuel economy due to driving conditions, such as more frequent traffic. Further, embodiments of the disclosure may help users understand a total cost of ownership based on better expectations of fuel economy.

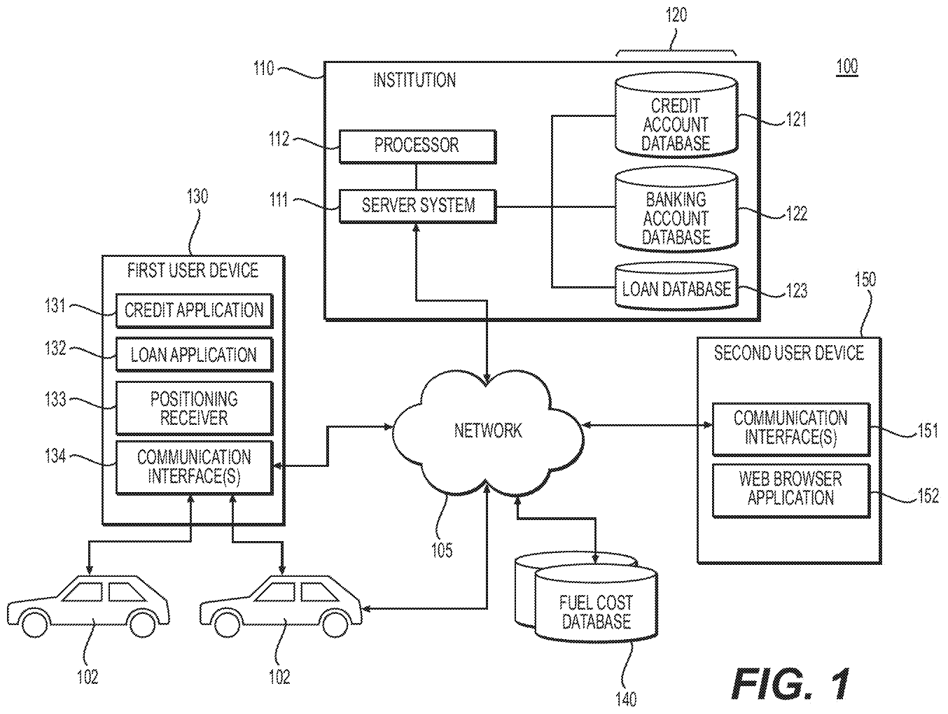

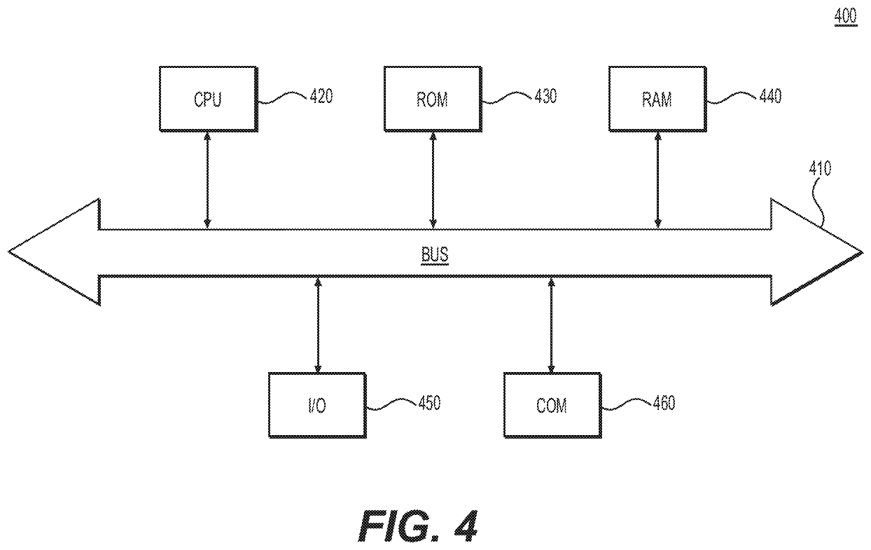

FIG. 1 is a diagram depicting an exemplary system environment 100 for determining fuel economy of a vehicle 102, according to embodiments of the present disclosure. As shown in FIG. 1, system environment 100 may include institution 110 (e.g., a financial service provider) having one or more server systems 111 (e.g., financial service provider server systems) and one or more databases, such as user account databases 120. Server system 111 may include computing systems, such as system 400 described with respect to FIG. 4. As such, server system 111 may include one or more processors and a memory for storing and executing applications or software modules of system environment 100. For example, server system 111 may include one or more software modules to communicate with user devices through a network 105, such as the Internet. Further, the one or more processors may be configured to access the memory and execute processor-readable instructions, which when executed by the processor configures the processor to perform a plurality of functions of the system environment 100. For example, the one or more processors may include a processor 112 for determining fuel economy of a vehicle 102, as detailed further below.

User account database 120 may include one or more databases of institution 110 and may include credit account database 121, banking account database 122, and loan database 123. Credit account database 121, banking account database 122, and loan database 123 may be provided in a shared database (e.g., a single database) or as one or more separate databases. Databases 121, 122, and 123 may store industry information including credit usage information (via credit account database 121), banking information (via banking account database 122), or loan information (via loan database 123). Specifically, credit account database 121 may store data representative of the purchase history of a first user having one or more credit accounts. The purchase history of the first user may include fuel payment information, such as a payment made for fuel at a fuel fill station. The fuel payment information may further include a location of the fuel fill station at which the payment was made. Banking account database 122 may store similar data that is obtained from a banking account of the first user when, for example, a bank account debit card is used to make a purchase. Loan database 123 may include data associated with one or more loans associated with a vehicle 102 of the first user, such as, for example, an auto loan. This data may include financing costs (e.g., principal, interest rates, etc.), loan availability, and information of the vehicle 102 associated with a respective loan. The information of the vehicle 102 may include, for example, manufacturer of the vehicle 102, model of the vehicle 102, and model year of the vehicle 102.

System environment 100 may also include one or more fuel cost databases 140 that may contain or store cost information per unit of fuel at various fuel fill locations (e.g., gas stations). For example, the one or more fuel cost databases 140 may store the prices per unit volume of fuel (e.g., gasoline) at each fuel fill location at various points in time. It is understood that the one or more fuel cost databases 140 may be provided as separate databases, one or more shared databases, and/or may be provided at institution 110. Processor 112 may access user account database 120 and fuel cost database 140 (via network 105) to obtain and receive the fuel payment information, the information of the vehicle 102, and the price for fuel at a respective fuel fill location, and use this information in determining fuel economy of the vehicle, as detailed further below.

As further shown in FIG. 1, system environment 100 may include user devices, such as a first user device 130 and a second user device 150. First user device 130 and second user device 150 may be in communication with each other and with server system 111 via network 105. Additionally, system 100 may include one or more vehicles 102.

Vehicle 102 may be a vehicle owned, operated, or otherwise associated with the first user. Vehicle 102 may be a car, truck, sport-utility vehicle, motorcycle, boat, or any other type of vehicle in which a user may desire to know a fuel economy for the vehicle. Vehicle 102 may be associated with first user device 130 for communicating information of vehicle 102 to processor 112 via network 105. For example, first user device 130 may include a loan application 132 that stores information of vehicle 102 via loan database 123. In some embodiments, vehicle 102 may be in communication with first user device 130 for communicating information of vehicle 102 to processor 112 via first user device 130. Alternatively, vehicle 102 may be in communication with processor 112 directly via network 105 for communicating information of vehicle 102 to processor 112. Each piece of information of vehicle 102 may be used by processor 112 to determine a fuel economy of vehicle 102, as detailed further below. As further shown in FIG. 1, system environment 100 may include a plurality of vehicles 102 such that processor 112 may determine a fuel economy of each of the plurality of vehicles 102.

First user device 130 may be a computer system, such as a mobile computer or cellular phone, that is operated by the first user. First user device 130 may include a memory, one or more processors, communication interfaces, input devices, and output devices, as detailed further below with reference to FIG. 4. First user device 130 may include a credit application 131, a loan application 132, a positioning receiver 133, such as a global positioning receiver or other geo-location device, and one or more communication interfaces 134. Communication interface may include one or more cellular radios, Bluetooth, WiFi, near-field communication radios, or other appropriate communication devices for transmitting and receiving information. As can be seen in FIG. 1, communication interface 134 facilitates communication between network 105 and first user device 130. Multiple communication interfaces 134 may be included in first user device 130 providing multiple forms of communication between first user device 130 and vehicle 102. For example, communication may be achieved by one or more cellular radios and/or WiFi communication between first user device 130 and vehicle 102. Communication also may be achieved through Bluetooth, near-field communication, a wired data connection (e.g., a universal serial bus, an onboard diagnostic system, etc.) or other communication modes.

Credit application 131 may send and receive credit card account and/or banking account information of the first user to credit account database 121 and/or banking account database 122 via network 105. For example, credit application 131 may obtain and send fuel payment information to credit account database 121 and/or banking account database 122 when first user pays for a fuel refill for vehicle 102. In some embodiments, fuel payment information may be sent to the databases 121 and/or 122 when first user uses a credit card and/or banking card at a fuel fill station. Credit application 131 may also obtain location information from positioning receiver 133 for sending a location of the fuel fill station at which first user pays for the fuel refill. Processor 112 may then access credit account database 121 and/or banking account database 122 to obtain the fuel payment information of the first user for vehicle 102 and/or the location information of the fuel fill station. It is understood that processor 112 may receive fuel payment information and location information from any source necessary, including other databases.

Loan application 132 may send and receive loan information of the first user to and from loan database 123 via network 105. For example, loan application 132 may obtain and send information of the vehicle 102 to loan database 123. Processor 112 may then access loan database 123 to receive information of the vehicle 102, including information of type of vehicle (e.g., manufacturer, model, and/or model year) for the vehicle 102. It is understood that processor 112 may receive the information of the vehicle 102 from any source necessary, including other databases.

First user device 130 may further include hardware configured to sense (measure) and record usage information when vehicle 102 is operated. For example, positioning receiver 133 may include, for example, a Global Positioning System receiver configured to determine a location of first user device 130. Communication interface 134 may also measure location based on data received from other satellite location systems or communication with a cell tower, for example. Positioning receiver 133 and communication interface 134 may independently or collaboratively measure acceleration, deceleration, speed (instantaneous or average), stops, geographic location (e.g., city/state/region), and travel route (e.g., trip information). Alternatively, or additionally, vehicle 102 may include a positioning receiver 133 and/or a communication interface 134 for measuring acceleration, deceleration, speed (instantaneous or average), stops, geographic location (e.g., city/state/region), and travel route (e.g., trip information).

Second user device 150 may be a computer system, such as a computer, a mobile computer, or a cellular phone, that is operated by a second user. Second user device 150 may include a memory, one or more processors, communication interfaces, input devices, and output devices, as detailed further below with reference to FIG. 4. Second user device 150 may include one or more communication interfaces 151 and a web browser application 152. Communication interface 151 may include one or more cellular radios, Bluetooth, WiFi, near-field communication radios, or other appropriate communication devices for transmitting and receiving information. As can be seen in FIG. 1, communication interface 151 facilitates communication between network 105 and second user device 150. Multiple communication interfaces 151 may be included in second user device 150 for providing multiple forms of communication between second user device 150 and network 105. Web browser application 152 may provide an interface for accessing websites, including a website that may display fuel economy of one or more vehicles 102. Thus, processor 112 may transmit the determined fuel economy for a respective vehicle 102 to second user device 150 via network 105, as detailed further below.

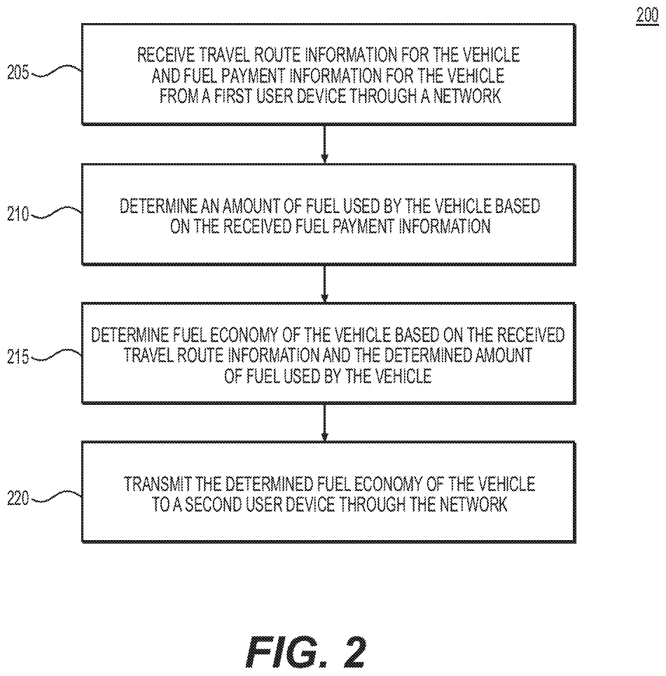

FIG. 2 depicts a flowchart of an exemplary method 200 for determining fuel economy of a vehicle 102, according to one or more embodiments, and may be performed in the exemplary system environment 100 of FIG. 1. In an initial step 205, processor 112 may receive travel route information for the vehicle and fuel payment information for the vehicle from first user device 130 through network 105. The travel route information for the vehicle may include, for example, a distance travelled in the vehicle 102 between a previous fuel refill for the vehicle 102 and a current fuel refill for the vehicle 102. In one embodiment, the travel route information for the vehicle 102 may be received from the credit application 131, the loan application 132 and/or from the vehicle 102 itself (e.g., obtained via positioning receiver 133). The fuel payment information may include, for example, a location of a fuel fill station of the current fuel refill for the vehicle 102 and a transaction amount for the current fuel refill for the vehicle 102. In one embodiment, the fuel payment information for the vehicle 102 may be received from the credit application 131, the loan application 132, and/or received from the fuel fill station via a credit card or banking card payment at the fuel fill station. The fuel payment information (e.g., the transaction amount for the current fuel refill) may be stored in the user account database 120 (e.g., banking account database 121 and/or credit account database 122).

In step 210, processor 112 may determine an amount of fuel used by the vehicle 102 based on the received fuel payment information. In one embodiment, processor 112 may determine the amount of fuel used by the vehicle 102 based on the transaction amount for the current fuel refill for the vehicle 102 and a cost of fuel at the location of the fuel fill station of the current fuel refill for the vehicle 102. For example, processor 112 may access user account database 120 to receive the transaction amount for the current fuel refill for the vehicle 102. Processor 112 may access the one or more fuel cost databases 140 to receive the cost of fuel (e.g., cost per unit volume of fuel) at the location of the fuel fill station of the current fuel refill for the vehicle 102.

In step 215, processor 112 may determine fuel economy of the vehicle 102 based on the received travel route information and the determined amount of fuel used by the vehicle 102. In one embodiment, processor 112 may determine the fuel economy of the vehicle 102 based on the distance travelled in the vehicle 102 between the previous fuel refill for the vehicle 102 and the current fuel refill for the vehicle 102 and the determined amount of fuel used by the vehicle 102. For example, processor 112 may divide the distance travelled by the determined amount of fuel used by the vehicle to determine the fuel economy. In other embodiments, processor 112 may divide the amount of fuel used by the vehicle 102 by the distance travelled by the vehicle 102 and multiply by one hundred to determine fuel economy of the vehicle 102.

In some embodiments, processor 112 may receive information of vehicle type for the vehicle 102. For example, processor 112 may receive the information of vehicle type for the vehicle 102 from loan application 132 and/or from the vehicle 102 itself (e.g., via an onboard computer). The information of vehicle type for the vehicle 102 may include, for example, manufacturer of the vehicle 102, model of the vehicle 102, and/or model year of the vehicle 102. The information of vehicle type of the vehicle 102 may be stored in user account database 120 (e.g., loan database 123) for the user. Processor 112 may associate the determined fuel economy for the vehicle 102 with the information of vehicle type for the vehicle 102 and a geographic location in which the vehicle 102 is located. For example, the determined fuel economy for the vehicle 102 may be associated with the manufacturer, model, and/or model year of the vehicle 102 and the geographic location for the vehicle 102. The geographic location in which the vehicle 102 is located may be, for example, a city, county, state, zip code, region, or any other geographic location indicator known in the art.

In some embodiments, the determined fuel economy may include a range or average for a number of similar vehicles 102. For example, similar vehicles 102 may include vehicles in a same class (e.g., size, type, etc.) of vehicles. The determined fuel economy for the similar vehicles 102 may include a range of determined fuel economies of the similar vehicles 102 and/or an average determined fuel economy of the similar vehicles 102. Further, if processor 112 does not have data for determining fuel economy for a particular vehicle 102, processor 112 may use the determined fuel economy for the similar vehicles 102 for the particular vehicle 102.

In some embodiments, processor 112 may determine fuel economy for a variety of vehicles 102 in the same, or similar, particular geographic location. Processor 112 may compare the determined fuel economy for the variety of vehicles 102 to the manufacturer-provided fuel economy to determine a performance of vehicles 102 in the particular geographic location. For example, based on the comparing, processor 112 may determine that the determined fuel economy of vehicles 102 in the particular geographic location is typically higher, the same, or lower than the manufacturer-provided fuel economy for vehicles 102. Further, if processor 112 does not have determined fuel economy for a particular vehicle 102 in a particular geographic location, processor 112 may use the determined performance of vehicles 102 in the particular geographic location for the particular vehicle 102 to transmit to a second user device 150, as detailed below.

In some embodiments, processor 112 may cluster similar particular geographic locations to extrapolate determined fuel economy for a variety of vehicles 102 from one particular geographic location to determine fuel economy of a variety of vehicles 102 in another particular geographic location. For example, if processor 112 does not have determined fuel economy data of vehicles 102 in a particular geographic location, processor 112 may determine fuel economy of vehicles 102 in that particular geographic location using determined fuel economy of vehicles 102 in another, similar particular geographic location.

In step 220, processor 112 may transmit the determined fuel economy of the vehicle to a second user device 150 through network 105. In one embodiment, processor 112 may transmit the determined fuel economy of the vehicle 102 with the information of vehicle type for the vehicle and the geographic location to the second user device 150 through network 105. For example, the information of vehicle type, determined fuel economy, and geographic location may be displayed on second user device 150 via web browser application 152 through network 105. In one embodiment, a second user may view the vehicle type, geographic location, and fuel economy for a vehicle via web browser application 152. In some embodiments, vehicle 102 may include a plurality of vehicles 102 and processor 112 may determine fuel economy for each of the plurality of vehicles 102. Processor 112 may transmit the determined fuel economy, the vehicle type, and the geographic location for each of the plurality of vehicles 102 to second user device 150 through network 105. For example, a second user may view a list of vehicles 102 for a geographic location, each vehicle 102 in the list including the determined fuel economy for that respective vehicle 102.

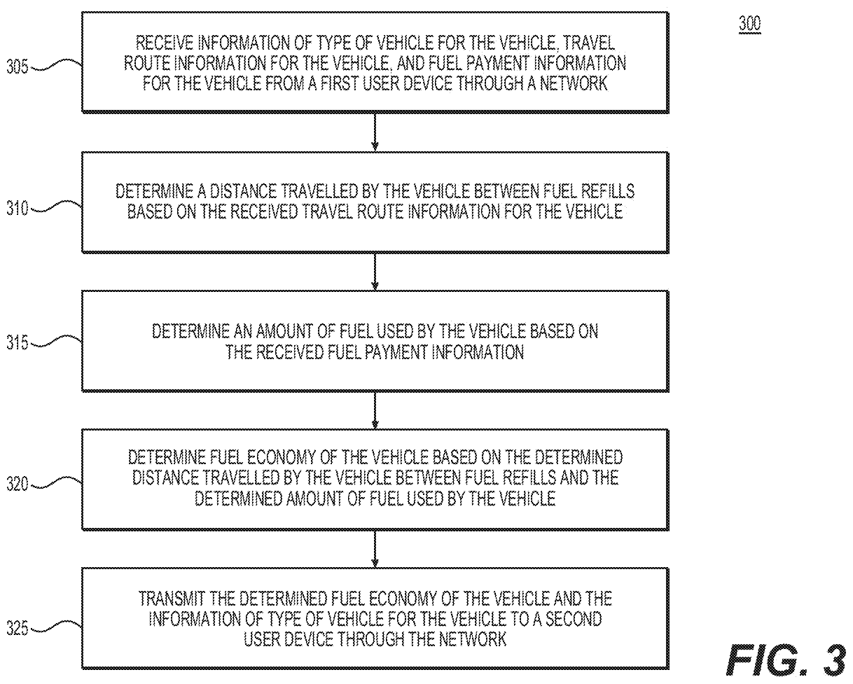

FIG. 3 depicts a flowchart of an exemplary method 300 for determining fuel economy of a vehicle 102, according to another embodiment. In an initial step 305, processor 112 may receive information of type of vehicle for the vehicle 102, travel route information for the vehicle 102, and fuel payment information for the vehicle 102 from first user device 130 through network 105.

In step 310, processor 112 may determine a distance travelled by the vehicle 102 between fuel refills based on the received travel route information for the vehicle 102.

In step 315, processor 112 may determine an amount of fuel used by the vehicle based on the received fuel payment information.

In step 320, processor 112 may determine fuel economy of the vehicle 102 based on the determined distance travelled by the vehicle 102 between fuel refills and the determined amount of fuel used by the vehicle 102.

In step 325, processor 112 may transmit the determined fuel economy of the vehicle 102 and the information of type of vehicle for the vehicle 102 to a second user device 150 through network 105.

FIG. 4 depicts an example system 400 that may execute techniques presented herein. FIG. 4 is a simplified functional block diagram of a computer that may be configured to execute techniques described herein, according to exemplary embodiments of the present disclosure. Specifically, the computer (or “platform” as it may not a be a single physical computer infrastructure) may include a data communication interface 460 for packet data communication. The platform also may include a central processing unit (“CPU”) 420, in the form of one or more processors, for executing program instructions. The platform may include an internal communication bus 410, and the platform also may include a program storage and/or a data storage for various data files to be processed and/or communicated by the platform such as ROM 430 and RAM 440, although the system 400 may receive programming and data via network communications. The system 400 also may include input and output ports 450 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method for determining fuel economy of a vehicle, the method comprising:
measuring, by a processor, travel route information for the vehicle through a global positioning system receiver included in at least one of the vehicle or a first user device, wherein the travel route information for the vehicle includes a distance travelled by the vehicle between a previous fuel refill for the vehicle and a current fuel refill for the vehicle;
receiving, by the processor, fuel payment information for the vehicle from the first user device, wherein the fuel payment information includes a location of a fuel fill station of the current fuel refill for the vehicle and a transaction amount for the current fuel refill for the vehicle;
determining, by the processor, a cost of fuel per unit volume of fuel at the location of the fuel fill station of the current fuel refill for the vehicle;
determining, by the processor, an amount of fuel used by the vehicle based on the transaction amount for the current fuel refill for the vehicle and the determined cost of fuel per unit volume of fuel at the location of the fuel fill station of the current fuel refill for the vehicle;
determining, by the processor, fuel economy of the vehicle based on the distance travelled by the vehicle between the previous fuel refill for the vehicle and the current fuel refill for the vehicle measured through the global positioning system receiver and also based on the determined amount of fuel used by the vehicle; and
transmitting, by the processor, the determined fuel economy of the vehicle to a second user device through a network for causing the second user device to display the determined fuel economy of the vehicle on a display of the second user device.

2-5. (canceled)

6. The method of claim 1, further comprising:
receiving, by the processor, information of vehicle type for the vehicle; and
associating, by the processor, the determined fuel economy of the vehicle with the information of vehicle type for the vehicle and a geographic location in which the vehicle is located measured through the global positioning system receiver.

7. The method of claim 6, wherein the transmitting, by the processor, the determined fuel economy of the vehicle to the second user device through the network for causing the second user device to display the determined fuel economy of the vehicle on a display of the second user device includes:
transmitting, by the processor, the determined fuel economy of the vehicle with the information of vehicle type for the vehicle and the geographic location to the second user device through the network for causing the second user device to display the determined fuel economy of the vehicle with the information of vehicle type for the vehicle and the geographic location on the display of the second user device.

8. The method of claim 7, wherein the information of vehicle type for the vehicle includes at least one of: a manufacturer of the vehicle, a model of the vehicle, or a model year of the vehicle.

9. The method of claim 1, wherein the vehicle is a first vehicle of a plurality of vehicles each located in a same geographic location.

10. The method of claim 9, wherein the transmitting, by the processor, the determined fuel economy of the vehicle to the second user device through the network for causing the second user device to display the determined fuel economy of the vehicle on a display of the second user device includes:
transmitting, by the processor, the determined fuel economy of each vehicle of the plurality of vehicles and the geographic location of the plurality of vehicles to the second user device through the network for causing the second user device to display the determined fuel economy of each of the plurality of vehicles and the geographic location of the plurality of vehicles on the display of the second user device.

11. A computer system for determining fuel economy of a vehicle, comprising:
a memory having processor-readable instructions stored therein; and
at least one processor configured to access the memory and execute the processor-readable instructions, which when executed by the processor configures the processor to perform a plurality of functions, including functions for:
measuring travel route information for the vehicle through a global positioning system receiver included in at least one of the vehicle or a first user device, wherein the travel route information for the vehicle includes a distance travelled by the vehicle between a previous fuel refill for the vehicle and a current fuel refill for the vehicle;
receiving fuel payment information for the vehicle from the first user device, wherein the fuel payment information includes a location of a fuel fill station of the current fuel refill for the vehicle and a transaction amount for the current fuel refill for the vehicle;
determining a cost of fuel per unit volume of fuel at the location of the fuel fill station of the current fuel refill for the vehicle;
determining an amount of fuel used by the vehicle based on the transaction amount for the current fuel refill for the vehicle and the determined cost of fuel per unit volume of fuel at the location of the fuel fill station of the current fuel refill for the vehicle;
determining fuel economy of the vehicle based on the distance travelled by the vehicle between the previous fuel refill for the vehicle and the current fuel refill for the vehicle measured through the global positioning system receiver and also based on the determined amount of fuel used by the vehicle; and
transmitting the determined fuel economy of the vehicle to a second user device through a network for causing the second user device to display the determined fuel economy of the vehicle on a display of the second user device.

12-15. (canceled)

16. The computer system of claim 11, further comprising:
receiving information of vehicle type for the vehicle; and
associating the determined fuel economy of the vehicle with the information of vehicle type for the vehicle and a geographic location in which the vehicle is located measured through the global positioning system receiver.

17. The computer system of claim 16, wherein the transmitting the determined fuel economy of the vehicle to the second user device through the network for causing the second user device to display the determined fuel economy of the vehicle on a display of the second user device includes:
transmitting the determined fuel economy of the vehicle with the information of vehicle type for the vehicle and the geographic location to the second user device through the network for causing the second user device to display the determined fuel economy of the vehicle with the information of vehicle type for the vehicle and the geographic location on the display of the second user device.

18. The computer system of claim 17, wherein the information of vehicle type for the vehicle includes at least one of: a manufacturer of the vehicle, a model of the vehicle, or a model year of the vehicle.

19. The computer system of claim 11, wherein the vehicle is a first vehicle of a plurality of vehicles each located in a same geographic location.

20. A computer-implemented method for determining fuel economy of a vehicle, the method comprising:
receiving, by a processor, information of type of vehicle for a plurality of first vehicles including at least one of manufacturer, model, and/or model year, from a plurality of first user devices each associated with a respective one of the plurality of vehicles through a network;
measuring, by the processor, travel route information for each of the plurality of first vehicles through a respective global positioning system receiver included in at least one of each respective one of the plurality of first vehicles or each respective one of the plurality of first user devices, wherein the travel route information for the plurality of first vehicles includes a distance travelled by each respective first vehicle between fuel refills for each respective first vehicle;
receiving, by the processor, fuel payment information for each of the plurality of first vehicles from each respective first user device through the network, wherein the fuel payment information includes a location of a fuel fill station of a current fuel refill for each respective first vehicle and a transaction amount for the current fuel refill for each respective first vehicle;
determining, by the processor, a cost of fuel per unit volume of fuel at the location of the fuel fill station of the current fuel refill for each respective first vehicle;
determining, by the processor, an amount of fuel used by each respective first vehicle based on the transaction amount for the current fuel refill for each respective first vehicle and the determined cost of fuel per unit volume of fuel at the location of the fuel fill station of the current fuel refill for each respective first vehicle;
determining, by the processor, fuel economy of each respective first vehicle based on the distance travelled by each respective first vehicle between fuel refills measured from each respective global positioning system receiver and based on the determined amount of fuel used by each respective first vehicle;
receiving, by the processor, information of type of vehicle for a particular vehicle including at least one of manufacturer, model, and/or model year, from a particular first user device associated with the particular vehicle through the network, wherein the particular vehicle is a similar type of vehicle as the plurality of first vehicles;
determining, by the processor, fuel economy of the particular vehicle based on the determined fuel economy of each of the plurality of first vehicles; and
transmitting, by the processor, the determined fuel economy of the particular vehicle and the information of type of vehicle for the particular vehicle to a second user device through the network for causing the second user device to display the determined fuel economy of the particular vehicle and the information of type of vehicle for the particular vehicle on a display of the second user device.

21. The method of claim 9, wherein the determining, by the processor, the fuel economy of the vehicle includes:
determining, by the processor, the fuel economy of each of the plurality of vehicles based on the distance travelled by each vehicle between a previous fuel refill for each vehicle and a current fuel refill for each vehicle and also based on a determined amount of fuel used by each vehicle.

22. The method of claim 21, wherein the determined fuel economy includes a range or average fuel economy for a number of similar types of vehicles of the plurality of vehicles.

23. The method of claim 21, further including determining, by the processor, fuel economy of a second vehicle that is a similar type of vehicle as the plurality of vehicles based on the determined fuel economy of the plurality of vehicles.

24. The method of claim 21, wherein the plurality of vehicles is a first plurality of vehicles in a first geographic location, and the method further includes:
determining, by the processor, fuel economy of a second plurality of vehicles in a second geographic location that is similar to the first geographic location based on the determined fuel economy of the first plurality of vehicles in the first geographic location.

25. The computer system of claim 19, wherein the determining the fuel economy of the vehicle includes:
determining the fuel economy of each of the plurality of vehicles based on the distance travelled by each vehicle between a previous fuel refill for each vehicle and a current fuel refill for each vehicle and also based on a determined amount of fuel used by each vehicle.

26. The computer system of claim 25, wherein the determined fuel economy includes a range or average fuel economy for a number of similar types of vehicles of the plurality of vehicles.

27. The computer system of claim 25, further including determining economy of a second vehicle that is a similar type of vehicle as the plurality of vehicles based on the determined fuel economy of the plurality of vehicles.

28. The computer system of claim 25, wherein the plurality of vehicles is a first plurality of vehicles in a first geographic location, and the plurality of functions further include functions for:
determining fuel economy of a second plurality of vehicles in a second geographic location that is similar to the first geographic location based on the determined fuel economy of the first plurality of vehicles in the first geographic location.
